(19) United States
(12) Patent Application Publication
(10) Pub. No.: US 2022/0291648 A1
(43) Pub. Date: Sep. 15, 2022

(54) CONTROL DEVICE

(71) Applicant: HONDA MOTOR CO., LTD., Tokyo (JP)

(72) Inventors: Akihiro SEKINO, Tokyo (JP); Teruki TAKAHASHI, Tokyo (JP)

(73) Assignee: HONDA MOTOR CO., LTD., Tokyo (JP)

(21) Appl. No.: 17/678,521

(22) Filed: Feb. 23, 2022

(30) Foreign Application Priority Data
Mar. 12, 2021 (JP) 2021-040635

(51) Int. Cl. G05B 15/02; G06F 21/10

(52) U.S. Cl. CPC G05B 15/02; G06F 21/105

(57) ABSTRACT

A control device, which is configured to communicate with a first moving object and a second moving object different from the first moving object, includes: a management unit configured to manage license data, which is acquired when a user uses the first moving object and enables a first function of the first moving object, in association with identification information of the user; and a control unit configured to perform control to enable a function of the second moving object based on the license data when the user uses the second moving object.

### CROSS REFERENCE TO RELATED APPLICATIONS

This application claims priority to Japanese Patent Application No. 2021-040635 filed on Mar. 12, 2021, the content of which is incorporated herein by reference.

### TECHNICAL FIELD

The present invention relates to a control device.

### BACKGROUND ART

In related art, there has been known a license management system that manages, when a user acquires license data that enables a function of a moving object such as a vehicle, the license data in association with the moving object and enables the function of the moving object.

However, even if the user acquires license data for a certain moving object, it is necessary to acquire new license data when the user uses another moving object, which may lead to deterioration of usability.

JP 2007-170898 A describes a configuration in which, in a service providing system that provides a service using a navigation system, various sensors, or the like, a scene and a service are associated with each other for each user who uses the moving object, and a service to be provided is read and provided according to specific users and scenes.

However, JP 2007-170898 A does not explicitly describe handling of the license data when the user uses another moving object. Therefore, there is room for further improvement in usability when using the moving object.

An object of the present invention is to provide a control device capable of improving usability when using a moving object.

### SUMMARY OF INVENTION

An aspect of the present invention provides a control device configured to communicate with a first moving object and a second moving object different from the first moving object. The control device includes: a management unit configured to manage license data, which is acquired when a user uses the first moving object and enables a first function of the first moving object, in association with identification information of the user: and a control unit configured to perform control to enable a function of the second moving object based on the license data when the user uses the second moving object.

### BRIEF DESCRIPTION OF DRAWINGS

FIG. 1 is a schematic diagram showing an example of a control system including a control device according to an embodiment;

FIG. 2 is a block diagram showing an example of hardware of the control device;

FIG. 3 shows an example of a management table for managing user license data;

FIG. 4 shows an example of a vehicle system mounted on a vehicle;

FIG. 5 is a flowchart showing an operation example when a user gets on a first vehicle and acquires license; and

FIG. 6 is a flowchart showing an operation example when the user gets on a second vehicle after the license is acquired by the first vehicle.

### DESCRIPTION OF EMBODIMENTS

Hereinafter, an embodiment of a control device of the present invention will be described with reference to the drawings. In the following description of the embodiment, an example in which a vehicle M such as an automobile serves as a moving object in the present invention will be described.

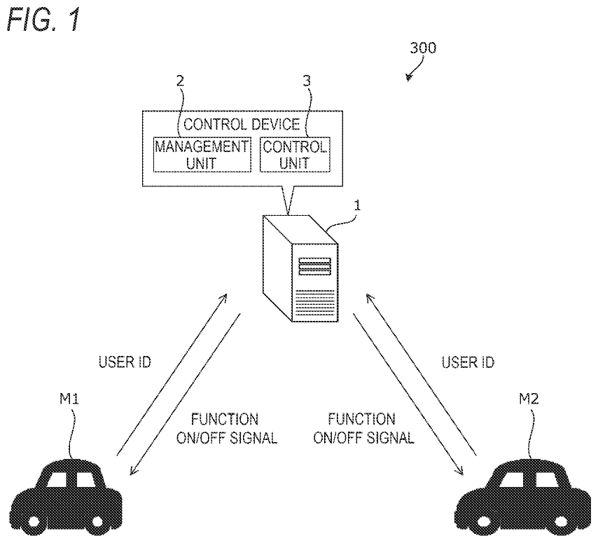

A control system 300 including a control device of the present embodiment will be described with reference to FIG. 1. As shown in FIG. 1, the control system 300 includes a control device 1 and a plurality of vehicles M capable of communicating with the control device 1. Although a first vehicle M1 and a second vehicle M2 are shown as two vehicles M in the present example, the number of vehicles is not limited to two as long as the number of vehicles is plural.

The control device 1 includes a management unit 2 and a control unit 3. The control device 1 is, for example, a server installed in a facility such as a management center. The management unit 2 manages license data related to vehicle license, which is acquired when a certain user uses the first vehicle M1 or the second vehicle M2, in association with the user (user ID).

The control unit 3 controls enabling and disabling (ON and OFF) of a function included in the first vehicle M1 or the second vehicle M2 when the user uses the first vehicle M1 or the second vehicle M2. Specifically, the control unit 3 performs control to switch between enabling and disabling of functions of the first vehicle M1 and the second vehicle M2 by transmitting a function ON signal for enabling a function and a function OFF signal for disabling a function to the first vehicle M1 and the second vehicle M2.

The first vehicle M1 and the second vehicle M2 are vehicles capable of performing so-called autonomous driving or assistant driving. In addition, the first vehicle M1 and the second vehicle M2 are vehicles whose users are limited, for example, vehicles owned by individuals, or vehicles whose users are not limited, for example, vehicles owned by corporations. Users who can use a vehicle owned by an individual include, for example, an owner of the vehicle, and family, relatives, friends of the owner. Vehicles owned by corporations include vehicles that can be used by an unspecified number of users who have made a predetermined contract, such as rental cars and share cars.

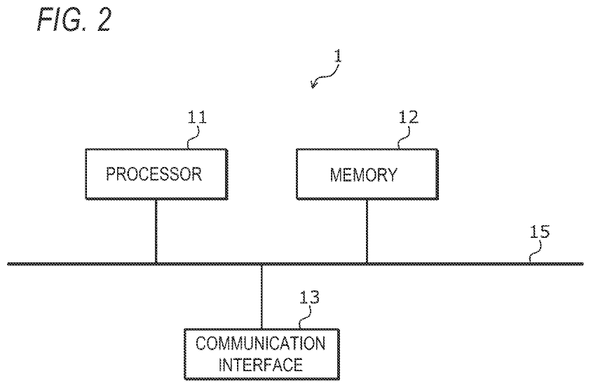

Next, a hardware configuration of the control device 1 will be described with reference to FIG. 2. As shown in FIG. 2, the control device 1 includes a processor 11, a memory 12, and a communication interface 13. The processor 11, the memory 12, and the communication interface 13 are connected by, for example, a bus 15.

The processor 11 is a circuit that performs signal processing, and is, for example, a central processing unit (CPU) that controls the entire control device 1. The processor 11 may be implemented by another digital circuit such as a field-programmable gate array (FPGA) or a digital signal processor (DSP). The processor 11 may also be implemented by combining a plurality of digital circuits.

The memory 12 includes, for example, a main memory and an auxiliary memory. The main memory is, for example, a random access memory (RAM). The main memory is used as a work area of the processor 11. The auxiliary memory is, for example, a non-volatile memory such as a magnetic disk or a flash memory. Various programs for operating the control device 1 are stored in the auxiliary memory. The programs stored in the auxiliary memory are loaded onto the main memory and executed by the processor 11. The auxiliary memory may also include a portable memory removable from the control device 1. Examples of the portable memory include a universal serial bus (USB) flash drive, a memory card such as a secure digital (SD) memory card, an external hard disk drive, and the like.

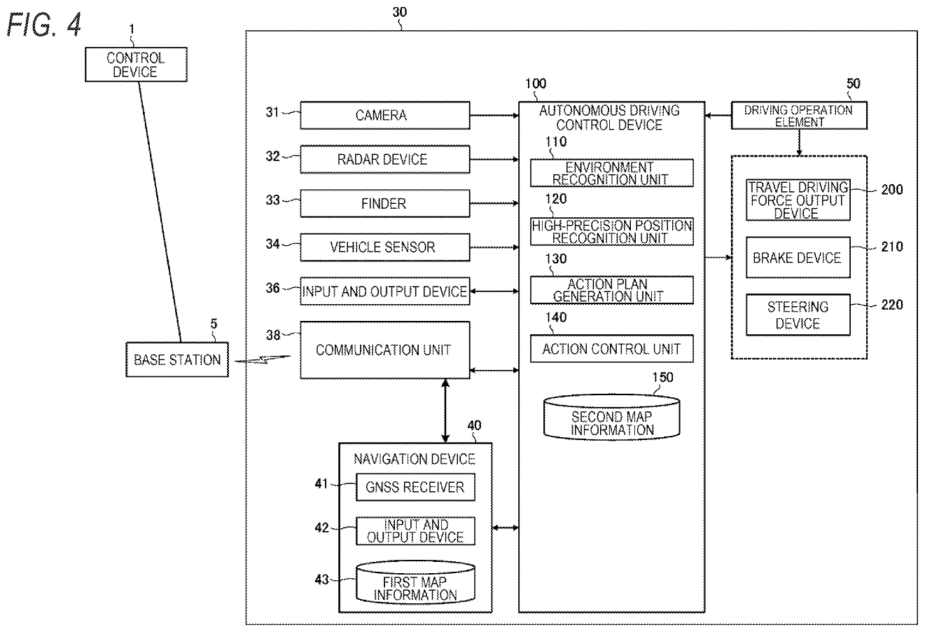

The communication interface 13 is a communication interface that performs communication with the outside of the control device 1 (for example, the first vehicle M1 or the second vehicle M2). For example, the communication interface 13 communicates with the first vehicle M1 via a base station 5 (see FIG. 4) in the vicinity of the first vehicle M1, and communicates with the second vehicle M2 via a base station 5 in the vicinity of the second vehicle M2. The base station 5 relays communication between the control device 1 and the first vehicle M1 by performing wireless communication with the first vehicle M1, and relays communication between the control device 1 and the second vehicle M2 by performing wireless communication with the second vehicle M2. The communication interface 13 is controlled by the processor 11.

The management unit 2 shown in FIG. 1 can be implemented by, for example, the processor 11 and the memory 12. The control unit 3 shown in FIG. 1 can be implemented by, for example, controlling the communication interface 13 by the processor 11.

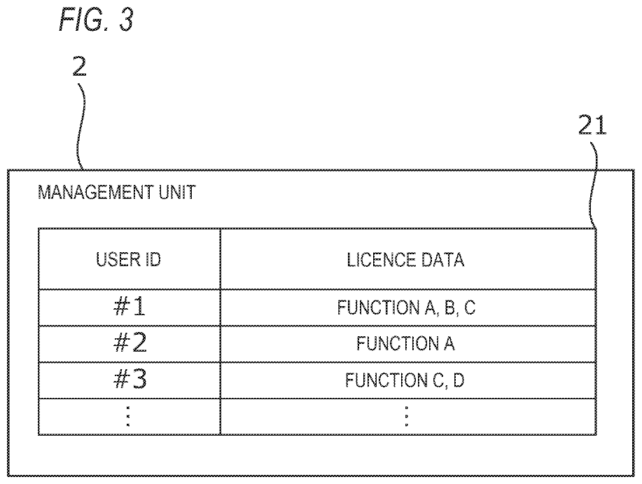

Next, license data managed by the management unit 2 of the control device 1 will be described with reference to FIG. 3. As shown in FIG. 3, the license data is stored in a management table 21 provided in the management unit 2.

The license data is data of a function that can be used by a user who uses the first vehicle M1 or the second vehicle M2 by selecting as desired from functions included in the first vehicle M1 or the second vehicle M2. When using the first vehicle M1 or the second vehicle M2, the user acquires license for enabling (allowing access to) the selected function, for example, by charging. The term “when using the vehicle” means when the vehicle is under management of the user. Specifically, in a case where the vehicle is a vehicle owned by an individual, the term means, for example, a time when the user purchases the vehicle from a manufacturer or causes the vehicle to travel for a first time. In a case where the vehicle is a vehicle owned by a corporation, the term means, for example, a time when the user makes a rental contract for the vehicle or when the user shares the vehicle.

The license data is stored in the management table 21 in association with identification information (for example, a user ID) assigned to the user. In the present example, license data indicating that functions A, B, and C of the vehicle are enabled by acquiring the license is stored in the management table 21 in association with a user ID “#1”. Similarly, license data indicating that the function A is enabled is stored in the management table 21 in association with a user ID “#2”. Similarly, license data indicating that functions C and D are enabled is stored in the management table 21 in association with a user ID “#3”.

The control unit 3 of the control device 1 performs control to switch between enabling and disabling of the functions of the first vehicle M1 and the second vehicle M2 based on information stored in the management table 21. For example, in a case where a user gets on the first vehicle M1 and acquires license for enabling a predetermined function among the functions included in the first vehicle M1, the control unit 3 performs control to enable a corresponding function in the second vehicle M2 based on the license acquired in the first vehicle M1 when the user gets on the second vehicle M2.

Next, a vehicle system 30 mounted on each vehicle M (the first vehicle M1 and the second vehicle M2) will be described with reference to FIG. 4. As shown in FIG. 4, the vehicle system 30 includes a camera 31, a radar device 32, a finder 33, a vehicle sensor 34, an input and output device 36, a communication device 38, a navigation device 40, a driving operation element 50, an autonomous driving control device 100, a travel driving force output device 200, a brake device 210, and a steering device 220. These devices are communicably connected to each other via a wired or wireless communication network. The communication network connecting these devices is, for example, a controller area network (CAN).

The camera 31 is a digital camera that captures an image of surroundings of the vehicle M (for example, the front of the vehicle M). Image data obtained by the capturing is output to the autonomous driving control device 100. The radar device 32 is, for example, a radar device using radio waves in a millimeter wave band. The radar device 32 detects a position of an object around the vehicle M (for example, in front of, behind, and beside the vehicle M), and outputs a detection result thereof to the autonomous driving control device 100. The finder 33 is, for example, laser imaging detection and ranging (LIDAR) that uses a predetermined laser beam to measure a distance to an object (target) around the vehicle M (for example, in front of, behind, and beside the vehicle M). A measurement result thereof is output to the autonomous driving control device 100.

The vehicle sensor 34 includes, for example, a vehicle speed sensor that detects a speed of the vehicle M, an acceleration sensor that detects acceleration of the vehicle M, an angular velocity sensor that detects angular velocity around a vertical axis of the vehicle M, an azimuth sensor that detects orientation of the vehicle M, and the like. The vehicle sensor 34 also includes a radio wave intensity sensor that detects intensity of a radio wave (that is, a communication environment) used for communication performed by the communication device 38. The vehicle sensor 34 also includes a face recognition device configured to recognize a face of a driver, a fingerprint sensor configured to detect a fingerprint of the driver, and a voiceprint sensor configured to detect a voiceprint of the driver. The vehicle sensor 34 outputs a detection result of each sensor to the autonomous driving control device 100.

The input and output device 36 includes an output device that outputs various types of information to a user of the vehicle M (hereinafter, also simply referred to as the user), and an input device that receives various input operations from the user. The output device of the input and output device 36 is, for example, a display that performs display based on a processing result of the autonomous driving control device 100. The output device may be a speaker, a buzzer, a display lamp, or the like.

The input device of the input and output device 36 is, for example, a touch panel or an operation button (a key, a switch, or the like) that outputs an operation signal corresponding to an input operation received from the user to the autonomous driving control device 100. For example, identification information for identifying the user, function information of the vehicle M that the user desires to acquire, and the like are input to the input device of the input and output device 36. The identification information input from the input device includes, for example, name, address, credit number, telephone number, and the like of the user. The function information of the vehicle M input from the input device includes function information related to autonomous driving and assistant driving. For example, function information related to safety of the vehicle M, function information related to comfort, and the like may be included.

The communication device 38 is wirelessly connected to the base station 5 and can communicate with the control device 1 via the base station 5. The communication device 38 transmits license information of the vehicle M acquired by the user and identification information capable of identifying the user to the control device 1 via the base station 5. These pieces of information are input from the input device of the input and output device 36. The communication device 38 may be constituted by, for example, a telematics control unit (TCU) capable of performing bidirectional communication. In addition, the communication device 38 may use, for example, a cellular network, a Wi-Fi (registered trademark) network, Bluetooth (registered trademark), dedicated short range communication (DSRC), or the like.

The navigation device 40 includes a global navigation satellite system (GNSS) receiver 41 and an input and output device 42. The navigation device 40 includes a storage device (not shown) such as a hard disk drive (hereinafter, also referred to as HDD) or a flash memory. First map information 43 is stored in the storage device. The first map information 43 is, for example, information indicating a road shape by a link indicating a road and nodes connected by the link. The first map information 43 may also include information indicating curvature of the road or a point of interest (POI).

The GNSS receiver 41 specifies a latitude and a longitude of a point where the vehicle M is located as a position of the vehicle M based on a signal received from a GNSS satellite. In addition, the navigation device 40 may specify or correct the position of the vehicle M by an inertial navigation system (INS) using output of the vehicle sensor 34.

The input and output device 42 includes an output device that outputs various types of information to the user and an input device that receives various input operations from the user. The output device of the input and output device 42 is, for example, a display that performs display based on a processing result of the navigation device 40 (for example, displays a route-on-map described later). The input device of the input and output device 42 is, for example, a touch panel or an operation button (a key, a switch, or the like) that outputs an operation signal corresponding to an input operation received from the user to the navigation device 40. The input and output device 42 may be shared with the input and output device 36.

Although detailed description is omitted, the navigation device 40 determines, for example, a route from the position of the vehicle M specified by the GNSS receiver 41 to a destination input by the user (hereinafter, also referred to as the route-on-map) with reference to the first map information 43. The navigation device 40 uses the input and output device 42 to guide the user of the determined route-on-map. In addition, the navigation device 40 is configured to be capable of outputting information indicating the specified position of the vehicle M and the determined route-on-map to the autonomous driving control device 100.

The driving operation element 50 includes various operation elements such as an accelerator pedal, a brake pedal, a shift lever, a steering wheel, a variant steering wheel, and a joystick. The driving operation element 50 is provided with a sensor that detects an operation amount or presence or absence of an operation performed on the driving operation element 50. A detection result of the sensor of the driving operation element 50 is output to a part or all of the autonomous driving control device 100, the travel driving force output device 200, the brake device 210, and the steering device 220.

The travel driving force output device 200 outputs a travel driving force (torque) to drive wheels so as to cause the vehicle M to travel. The travel driving force output device 200 includes, for example, a motor and a motor electronic control unit (ECU) that controls the motor. The motor ECU controls the motor based on the detection result of the sensor of the driving operation element 50 (for example, the accelerator pedal) and control information from the autonomous driving control device 100. In a case where the vehicle M includes an internal combustion engine or a transmission as a drive source, the travel driving force output device 200 may also include the internal combustion engine or the transmission and an ECU that controls the internal combustion engine or the transmission.

The brake device 210 includes, for example, a brake caliper, a cylinder that transfers hydraulic pressure to the brake caliper, a motor that generates the hydraulic pressure in the cylinder, and a brake ECU. The brake ECU controls the motor of the brake device 210 based on the detection result of the sensor of the driving operation element 50 (for example, the brake pedal) and the control information from the autonomous driving control device 100 such that brake torque is output to each wheel in accordance with a braking operation.

The steering device 220 includes, for example, a steering ECU and a motor. The motor of the steering device 220 changes orientation of a steered wheel by applying a force to, for example, a rack-and-pinion mechanism. The steering ECU drives the motor of the steering device 220 based on the detection result of the sensor of the driving operation element 50 (for example, the steering wheel) and the control information from the autonomous driving control device 100 so as to change the orientation of the steered wheel (that is, a steering angle).

The autonomous driving control device 100 includes an environment recognition unit 110, a high-precision position recognition unit 120, an action plan generation unit 130, and an action control unit 140. The autonomous driving control device 100 also includes a storage device (not shown) implemented by a flash memory or the like that can be accessed by each functional unit (for example, the high-precision position recognition unit 120) of the autonomous driving control device 100. Second map information 150 is stored in the storage device.

The environment recognition unit 110 performs a sensor fusion process on information acquired by a part or all of the camera 31, the radar device 32, and the finder 33 so as to recognize an object around the vehicle M and recognize a position thereof. The environment recognition unit 110 recognizes, for example, an obstacle, a road shape, a traffic light, a guardrail, a utility pole, a surrounding vehicle (including a traveling state such as a speed or acceleration, and a parking state), a lane mark, a pedestrian, and the like, and recognizes positions thereof.

The high-precision position recognition unit 120 recognizes a detailed position and posture of the vehicle M with reference to the position of the vehicle M specified by the navigation device 40, the detection result of the vehicle sensor 34, the image captured by the camera 31, the second map information, and the like. For example, the high-precision position recognition unit 120 recognizes a traveling lane in which the vehicle M travels, or recognizes a relative position and a posture of the own vehicle relative to the traveling lane.

The action plan generation unit 130 generates an action plan of the vehicle M. Specifically, the action plan generation unit 130 generates a target trajectory along which the vehicle M will travel in the future as the action plan of the vehicle M. The target trajectory is, for example, information expressed by arranging points (trajectory points) that the vehicle M is to reach for each predetermined travel distance (for example, about several [m]). The target trajectory may also include information on a speed element such as a target speed or target acceleration of the vehicle M at each predetermined time or at each trajectory point.

The action control unit 140 performs control in such a manner that the vehicle M acts in accordance with the action plan generated by the action plan generation unit 130. Specifically, the action control unit 140 controls the travel driving force output device 200, the brake device 210, and the steering device 220 such that the vehicle M passes along the target trajectory generated by the action plan generation unit 130 at a scheduled time. For example, the action control unit 140 controls the travel driving force output device 200 and the brake device 210 based on the speed element associated with the target trajectory, and controls the steering device 220 in accordance with a degree of curvature of the target trajectory.

The second map information 150 is map information having higher accuracy than the first map information 43. The second map information 150 includes, for example, information indicating a center of a lane, information indicating a boundary line between lanes (for example, road lane marking), and the like. The second map information 150 may also include road information, traffic regulation information, address information, facility information, telephone number information, and the like. The second map information 150 may be updated at any time. The second map information 150 may be updated based on, for example, information acquired by a part or all of the camera 31, the radar device 32, and the finder 33.

Each functional unit of the autonomous driving control device 100 is implemented, for example, by executing a predetermined program (software) by a CPU. In addition, a part or all of functional units of the autonomous driving control device 100 may be implemented by hardware such as a large scale integration (LSI), an application specific integrated circuit (ASIC), an FPGA, or a graphics processing unit (GPU). For example, the storage device that stores the second map information 150 and the high-precision position recognition unit 120 may be implemented by a map positioning unit (MPU). Further, a part or all of the functional units included in the autonomous driving control device 100 may be implemented by cooperation of software and hardware.

Each vehicle M (the first vehicle M1 and the second vehicle M2) on which the vehicle system 30 having such a configuration is mounted is a vehicle capable of autonomous driving by autonomous driving control. Levels of the autonomous driving are classified into levels 0 to 5 according to a level of automation, for example, based on SEAJ3016 determined by SAE International. A high automation level means, for example, that a degree of vehicle control based on an operation of the driver (user) on the vehicle M is low, that is, there are less tasks required to be performed by the driver, such as monitoring surroundings of the vehicle M.

Specifically, the level 0 is an operation level without automation. At level 0, the driver performs all driving operations. The level 1 is a driving level at which the vehicle M performs any one operation among acceleration, steering, and braking (driving assistance). At the level 1, the vehicle M controls an operation performed on any one of an accelerator, a brake, and a steering wheel according to surrounding situations under a specific condition, while all the other driving operations are performed by the driver of the vehicle M.

The level 2 is a driving level at which the vehicle M performs a plurality of operations among acceleration, steering, and braking at a time (partial driving automation). At level 2, the driver of the vehicle M is obliged to monitor the surroundings. The level 3 is a driving level at which the vehicle system 30 performs all of acceleration, steering, and braking and the driver responds only when requested by the vehicle system 30 (conditional autonomous driving). At the level 3, the vehicle system 30 monitors the surroundings, and the driver of the vehicle M is not obliged to monitor the surroundings.

The level 4 is a driving level at which the vehicle system 30 performs all driving operations, and the driver of the vehicle M does not have to take place of the vehicle system 30 even when the vehicle system 30 cannot continue driving (advanced autonomous driving). The level 5 is a driving level at which the vehicle system 30 performs autonomous driving under all conditions (fully autonomous driving). Accordingly, the vehicle system 30 responds even in an emergency at the level 4 and the level 5.

The above-described condition under which the driving of the level 0 to the level 5 is performed is an example, and it may also be set as desired such that the automation level of the vehicle M increases, that is, tasks for the driver decrease in the order of level 5, level 4, level 3, level 2, level 1, and level 0. For example, a part or all of the level 1 to the level 5 may be in a state of autonomous driving, or a part or all of the level 1 to the level 5 may be in a state where driving assistance is performed instead of autonomous driving. In addition, the number of the classified operation levels is not limited to six.

The functions included in the vehicle M are functions related to autonomous driving and assistant driving of the vehicle M. The functions included in the vehicle M may include all functions related to the autonomous driving and the assistant driving of the vehicle M. For example, the driving levels 1 to 5 of the vehicle M described above may correspond to the functions A to E included in the vehicle M, respectively. In addition, for example, an automatic follow-up control function (adaptive cruise control system), a lane keeping assist function (lane keeping assist system), a constant speed traveling function, a lane changing function, a takeover function, a branching function, a merging function, and the like may be provided as the functions included in the vehicle M.

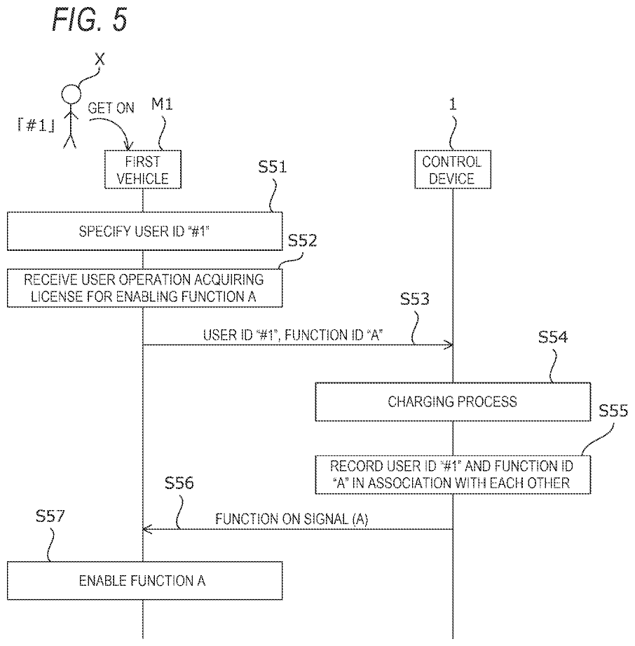

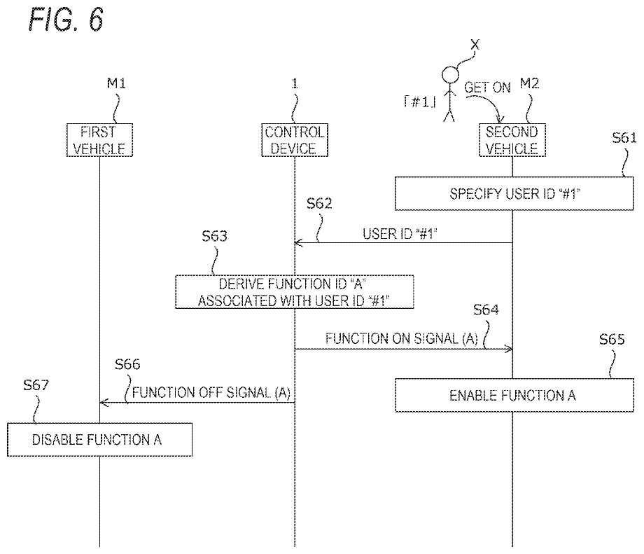

Next, an operation example of the control system 300 will be described with reference to FIGS. 5 and 6. In the present operation example, an operation in a case where a user X first gets on the first vehicle M1 whose user is limited and then gets on the second vehicle M2 whose user is similarly limited will be described. It is assumed that both the first vehicle M1 and the second vehicle M2 whose users are limited are vehicles owned by the user X.

FIG. 5 shows an operation of the control system 300 when the user X having the user ID “#1” gets on the first vehicle M1 and acquires license for a function desired to be used by the user X among the functions included in the first vehicle M1.

First, the first vehicle M1 specifies the user ID “#1” of the user X who gets on the first vehicle M1 (step S51). For example, the first vehicle M1 specifies the user ID “#1” by acquiring user information such as a face image, a fingerprint, or a voiceprint of the user X getting on the first vehicle M1 by the vehicle sensor 34. Alternatively, the first vehicle M1 may specify the user ID “#1” upon receiving input of the user ID “#1”, a password, and the like input from the user X by a touch panel or the like of the input and output device 36.

Next, the first vehicle M1 receives a user operation, which is an input operation for acquiring license for enabling the function of the first vehicle M1, from the input and output device 36 (step S52). In the present operation example, it is assumed that the user X performs a user operation for acquiring license for enabling the function A among the functions included in the vehicle M1.

Next, the first vehicle M1 transmits the user ID “#1” of the user X and a function ID “A” indicating the function A to the control device 1 (step S53).

Upon receiving the user ID “#1” and the function ID “A” from the first vehicle M1, the control device 1 performs a charging process for the user X indicated by the user ID “#1” regarding the function A indicated by the function ID “A” (step S54). For example, the control device 1 performs the charging process based on a registered credit number (identification information) of the user X.

Next, the control device 1 records the received user ID “#1” and the function ID “A” in association with each other in the management table 21 of the management unit 2 (step S55).

Next, the control device 1 transmits a function ON signal (A) for enabling the function A of the first vehicle M1 to the first vehicle M1 based on the recorded function ID “A” (step S56).

The first vehicle M1 enables the function A of the first vehicle M1 upon receiving the function ON signal (A) from the control device 1 (step S57). As a result, the user X can use the function A of the first vehicle M1.

FIG. 6 shows an operation of the control system 300 when the user X gets on the second vehicle M2 after the user X acquires the license for enabling the function A in the first vehicle M1 as shown in FIG. 5.

The second vehicle M2 specifies the user ID “#1” of the user X who gets on the second vehicle M2 (step S61). A method of specifying the user ID “#1” in step S61 is the same as the method of specifying the user ID “#1” in step S51 of FIG. 5.

Next, the second vehicle M2 transmits the specified user ID “#1” to the control device 1 (step S62).

Upon receiving the user ID “#1” from the second vehicle M2, the control device 1 detects the user ID “#1” from the management table 21 of the management unit 2, and derives the function ID “A” associated with the detected user ID “#1” (step S63).

Next, the control device 1 transmits the function ON signal (A) for enabling the function A of the second vehicle M2 to the second vehicle M2 based on the derived function ID “A” (step S64).

The second vehicle M2 enables the function A of the second vehicle M2 upon receiving the function ON signal (A) from the control device 1 (step S65). As a result, the user X can use the function A of the second vehicle M2.

In addition, the control device 1 transmits a function OFF signal (A) for disabling the function A of the first vehicle M1 to the first vehicle M1 based on the derived function ID “A” (step S66).

The first vehicle M1 disables the function A of the first vehicle M1 upon receiving the function OFF signal (A) from the control device 1 (step S67).

As described above, according to the control device 1, even in the case where the user X uses the plurality of vehicles M (the first vehicle M1 and the second vehicle M2), the license for enabling the function A of the first vehicle M1 acquired when the user X uses the one first vehicle M1 can also enable the function A of the second vehicle M2 when using the other second vehicle M2. Therefore, it is not necessary to additionally acquire the license for enabling the function A when using the second vehicle M2, and thus usability can be improved.

In the operation example of the control system 300 in FIGS. 5 and 6, the case where the user X first gets on the first vehicle M1 whose user is limited and then gets on the second vehicle M2 whose user is similarly limited has been described. However, the present invention is not limited thereto, and there may also be a case of getting on as follows.

For example, there may also be a case where the user X first gets on the first vehicle M1 whose user is not limited, and then gets on the second vehicle M2 whose user is similarly not limited. The first vehicle M1 and the second vehicle M2 whose users are not limited are both vehicles owned by corporations. In addition, for example, there may also be a case where the user X first gets on the first vehicle M1 whose user is limited (owned by an individual), and then gets on the second vehicle M2 whose user is not limited (owned by a corporation). In such a case, the license for enabling the function of the first vehicle M1 acquired by the user X when using the one first vehicle M1 can also enable the function of the second vehicle M2 when using the other second vehicle M2.

In contrast, for example, in a case where the user X first gets on the first vehicle M1 whose user is not limited (owned by a corporation) and then gets on the second vehicle M2 whose user is limited (owned by an individual), predetermined use history of the user X relative to the first vehicle M1 may become an additional condition in order to enable the function of the second vehicle M2 based on the license acquired by the user X in the first vehicle M1. For example, as the additional condition, time during which the user X uses the first vehicle M1 owned by the corporation, the number of times of use, a charged amount, and the like are required to reach a predetermined value. The charged amount may include, for example, charging for borrowing a child seat at the time of rental, charging for a high-price insurance contract, and the like.

In the operation example of the control system 300 shown in FIGS. 5 and 6, when the user X acquires the license for enabling the function A of the first vehicle M1 when using the first vehicle M1, the function enabled in the second vehicle M2 when using the second vehicle M2 is limited to be the same function as the function A enabled in the first vehicle M1. However, the same function may include the same type of function having a slight difference depending on a vehicle type. Therefore, when the user X uses the second vehicle M2, for example, in a case where the user X desires to enable the function B different from the function A among the functions (for example, the function A to a function J) included in the second vehicle M2, new license for enabling the function B may be acquired by performing new license registration (contract) at the time of using the second vehicle M2. The license registration can be performed via, for example, the input and output device 36. In a case where the license for enabling the function B is acquired by new license registration of the second vehicle M2, a function ID “B” related to the acquired license and the user ID “#1” are transmitted from the second vehicle M2 to the control device 1. The control device 1 records the received user ID “#1” and the function ID “B” in association with each other in the management table 21. The control device 1 transmits a function ON signal (B) for enabling the function B of the second vehicle M2 to the second vehicle M2 based on the recorded function ID “B”.

As described above, in the case where the license for enabling the function B of the second vehicle M2 is acquired by performing the new license registration in the second vehicle M2, the control device 1 may perform control to enable the function B of the first vehicle M1 based on the license acquired by the new license registration of the second vehicle M2 when the user X uses the first vehicle M1 again. In addition, when the user X acquires the new license for the function B of the second vehicle M2, the control device 1 may set a license registration condition of the function B depending on how much the user X uses the first vehicle M1. For example, a registration fee of the new license for the function B may be discounted based on the use history such as the time during which the user X uses the first vehicle M1, the number of times of use, and the charged amount.

In the operation example of FIG. 6, the control device 1 performs control to disable the function A of the first vehicle M1 (refer to S66) when the function A of the second vehicle M2 is enabled (refer to S64) based on the license for enabling the function A acquired by the user X. However, for example, when the disabled function A of the first vehicle M1 is enabled based on the same license, the control device 1 performs control to disable the function A of the second vehicle M2. That is, the control device 1 performs control, based on the acquired license, to disable the function of the second vehicle M2 while the function of the first vehicle M1 is enabled, and disable the function of the first vehicle M1 while the function of the second vehicle M2 is enabled.

The license acquired when the user X uses the first vehicle M1 may be license of a type that limits a person who can use the vehicle to be the user X, or may be license of a type that allows a family, a relative, or a friend in addition to the user X to use.

For example, in a case where the user X acquires license for enabling the functions A to E when using the first vehicle M1, then purchases the second vehicle M2 instead of the first vehicle M1, and the second vehicle M2 is a vehicle including the functions A to C and not including the functions D and E, the control device 1 may perform control to prevent charging for the functions D and E when the user X uses the second vehicle M2.

For example, in a case where the user X acquires license for enabling the functions A to E when using the first vehicle M1, then purchases the second vehicle M2 including the functions A to C, and then purchases a third vehicle M3 including the functions A to E, when the user X re-acquires the license for enabling the functions D and E when using the third vehicle M3, the control device 1 may perform control to discount a re-purchase cost for the functions D and E since the functions D and E are included in the license acquired when using the first vehicle M1.

Although the embodiment of the present invention have been described above, the present invention is not limited to the above-described embodiment, and modifications, improvements, and the like can be made as appropriate.

For example, although an example in which the moving object is a vehicle has been described in the above-described embodiment, the present invention is not limited thereto. The concept of the present invention can be applied not only to a vehicle but also to a robot, a ship, an aircraft, and the like that are provided with a drive source and movable by power of the drive source.

At least the following matters are described in the present specification. It should be noted that although constituent elements corresponding to those in the above-described embodiment are shown in parentheses, the constituent elements are not limited thereto.

(1) A control device (control device 1) configured to communicate with a first moving object (first vehicle M1) and a second moving object (second vehicle M2) different from the first moving object, the control device including: a management unit (management unit 2) configured to manage license data, which is acquired when a user uses the first moving object and enables a first function of the first moving object, in association with identification information of the user; and a control unit (control unit 3) configured to perform control to enable a function of the second moving object based on the license data when the user uses the second moving object.

According to (1), even when the user uses a plurality of moving objects, license data acquired when the user uses one moving object can enable a function even at the time of using another moving object, and thus it is not necessary to additionally acquire the license data Therefore, usability can be improved.

(2) The control device according to (1),

in which, when both the first moving object and the second moving object are moving objects whose user is limited or when both the first moving object and the second moving object are moving objects whose user is not limited, the control unit performs control to enable the function of the second moving object based on the license data.

According to (2), for example, the usability can still be improved when both the first moving object and the second moving object are moving objects owned by individuals, or when both the first moving object and the second moving object are moving objects owned by corporations.

(3) The control device according to (1) or (2),

in which, when the first moving object is a moving object whose user is limited and the second moving object is a moving object whose user is not limited, the control unit performs control to enable the function of the second moving object based on the license data.

According to (3), for example, when license data is acquired in the first moving object owned by an individual, it is not necessary to additionally acquire license data even if the second moving object is owned by a corporation, and thus the usability can be improved.

(4) The control device according to any one of (1) to (3),

in which, when the first moving object is a moving object whose user is not limited and the second moving object is a moving object whose user is limited, the control unit performs control to enable the function of the second moving object based on the license data on condition that the user satisfies an additional condition different from acquisition of the license data.

According to (4), when license data is acquired in the first moving object which is not owned by an individual, the additional condition for enabling the function of the second moving object that is owned by an individual can be set, and thus a flexible license form can be achieved.

(5) The control device according to (4),

in which the additional condition is a condition related to use history of the first moving object used by the user.

According to (5), even if the first moving object is not owned by an individual, the function of the second moving object owned by an individual can be enabled if the first moving object is frequently used, and thus the flexible license form can be achieved.

(6) The control device according to any one of (1) to (5),

in which the control unit performs control to enable a first function among functions of the second moving object that is the same as the first function of the first moving object based on the license data when the user uses the second moving object.

According to (6), among the functions of the second moving object, a function different from the first function of the first moving object that is enabled by the license data is not enabled, thus different license data is required for a function unique to the second moving object, and thus the flexible license form can be achieved.

(7) The control device according to (6),

in which, when new license data that enables a second function different from the first function among the functions of the second moving object is obtained while the user uses the second moving object, the control unit performs control to enable the second function of the second moving object.

According to (7), for a function for which license data has not been acquired in the first moving object, the function can be enabled by acquiring new license data in the second moving object, so that the flexible license form can be achieved.

(8) The control device according to (7),

in which, when the user uses the first moving object, the control unit performs control to enable, based on the new license data, a second function among functions of the first moving object that is enabled by the new license data and is the same as the second function of the second moving object.

According to (8), for a function enabled by acquiring new license data in the second moving object, the same function can also be enabled when the first moving object is used, so that the flexible license form can be achieved.

(9) The control device according to (7) or (8),

in which the control unit executes a process for the user to acquire the new license data, and sets a condition for the user to acquire the new license data based on the use history of the first moving object used by the user.

According to (9), it is easy for the user to use the function in the plurality of moving objects.

(10) The control device according to any one of (1) to (9),

in which, based on the license data, the control unit performs control to disable the function of the second moving object while the first function of the first moving object is enabled, and disable the first function of the first moving object while the function of the second moving object is enabled.

According to (10), the function based on the license data associated with the user can be prevented from being enabled in a plurality of moving objects at the same time, and thus unauthorized use of the function of the moving object can be prevented.

What is claimed is:

1. A control device configured to communicate with a first moving object and a second moving object different from the first moving object, the control device comprising:
a management unit configured to manage license data, which is acquired when a user uses the first moving object and enables a first function of the first moving object, in association with identification information of the user; and
a control unit configured to perform control to enable a function of the second moving object based on the license data when the user uses the second moving object.

2. The control device according to claim 1,
wherein, when both the first moving object and the second moving object are moving objects whose user is limited or when both the first moving object and the second moving object are moving objects whose user is not limited, the control unit performs control to enable the function of the second moving object based on the license data.

3. The control device according to claim 1,
wherein, when the first moving object is a moving object whose user is limited and the second moving object is a moving object whose user is not limited, the control unit performs control to enable the function of the second moving object based on the license data.

4. The control device according to claim 1,
wherein, when the first moving object is a moving object whose user is not limited and the second moving object is a moving object whose user is limited, the control unit performs control to enable the function of the second moving object based on the license data on condition that the user satisfies an additional condition different from acquisition of the license data.

5. The control device according to claim 4,
wherein the additional condition is a condition related to use history of the first moving object used by the user.

6. The control device according to claim 1,
wherein the control unit performs control to enable a first function among functions of the second moving object that is the same as the first function of the first moving object based on the license data when the user uses the second moving object.

7. The control device according to claim 6,
wherein, when new license data that enables a second function different from the first function among the functions of the second moving object is obtained while the user uses the second moving object, the control unit performs control to enable the second function of the second moving object.

8. The control device according to claim 7,
wherein, when the user uses the first moving object, the control unit performs control to enable, based on the new license data, a second function among functions of the first moving object that is the same as the second function of the second moving object.

9. The control device according to claim 7,
wherein the control unit is configured to execute a process for the user to acquire the new license data, and to set a condition for the user to acquire the new license data based on the use history of the first moving object used by the user.

10. The control device according to claim 1,
wherein, based on the license data, the control unit is configured to perform control to disable the function of the second moving object while the first function of the first moving object is enabled, and disable the first function of the first moving object while the function of the second moving object is enabled.
